(19) United States
(12) Patent Application Publication
(10) Pub. No.: US 2009/0009519 A1
(43) Pub. Date: Jan. 8, 2009

(54) Specifying Wildcard Characters for Priority in XLFD At Font Set Creation

(76) Inventor: Shoji Sugiyama, Tokyo (JP)

Correspondence Address: LIEBERMAN & BRANDSDORFER, LLC, 802 STILL CREEK LANE, GAITHERSBURG, MD, 20878, US

(21) Appl. No.: 11/774,119

(22) Filed: Jul. 6, 2007

(51) Int. Cl. G06T 11/00; G06F 17/21; G06F 3/023

(52) U.S. Cl. 345/467

(57) ABSTRACT

A method and system are provided for creating a font set in an X Window computer system that supports use of prioritization of fields in an X logical font description. Two or more continuous wildcard characters may be applied to one or more fields of the X logical font description. A field with continuous multiple wildcard characters will have a higher priority than a field with fewer or no wildcard characters. Based upon the prioritization of the fields, a font set is created with one or more fonts from a font library.

### BACKGROUND OF THE INVENTION

1. Technical Field

This invention relates to a method and apparatus for creating a font set for use in an X Window System. More specifically, the invention relates to use of wildcard characters to specify multiple fields of a font set and establishing priorities among the specified fields within the X Window System.

2. Description of the Prior Art

In typography, a typeface is a coordinated set of glyphs designed with stylistic unity. A typeface usually comprises an alphabet of letters, numerals, and punctuation marks. It may also include ideograms and symbols, or consist entirely of them, for example, mathematical or map-making symbols. The term typeface is often interchanged with the term font. A helpful and still valid distinction between font and typeface is a font's status as a discrete commodity with legal restrictions, while typeface designates a visual appearance or style not immediately reducible to any foundry's production or proprietary control. The size of typefaces and fonts is traditionally measured in points. A point has been defined differently at different times, but currently the most popular is the Desktop Publishing Point. Font size is also commonly measured in millimeters (mm) and inches.

A font is a set of characters in a specific typeface, at a specific point size and in a specific style. The height of characters in a font is measured in point size or points, and the width is measured by pitch. More specifically, the pitch refers to how many characters can fit in an inch. A font is said to be fixed pitch when every character has the same width. If the widths vary depending on the shape of the character, the font is referred to as a proportional font. Each letter or image in a font is also referred to as a glyph.

In a computing environment, the X Window System is a networking and display protocol which provides windowing on bitmap displays. It provides a standard toolkit in the form of libraries and protocol to build graphical user interfaces on UNIX and Unix-like operating systems. Fonts are resources that are managed by the X server operating in the X Window System. The availability of fonts will vary from environment to environment.

An X logical font description (XLFD) is a specification for the description rule of the font attributes of a font set or a font. It is a string of characters that describes the properties of the font. The form of the XLFD includes the following fourteen fields. The first field is the Foundry, which is the name of the digital type foundry that digitized the font data. The second field is the family name, which is the commercial name of the font typeface. The third field is the weight name, which is the relative weight of the font. An example of a weight can be bold or italics. The fourth field is the slant, which is a code indicating the direction of the slant for the font, such as slant left or slant right. The fifth field is the set width field, which is the width per unit of the font. An example of a set width field is compressed or expanded. The sixth field is the add style name, which is a description of anything else needed to uniquely identify the font, such as serif or cursive. The seventh field is the pixel size, which is an integer describing the height of a square in pixels. The eighth field is the point size field, which an integer is giving the square size in decimal ( 1/10) points. The ninth field is the resolution X field and the tenth field is the resolution Y field. Both of these fields are the horizontal and vertical screen resolution, respectively, of the device that the font was designed for. The eleventh field is the spacing field, and more specifically, the spacing between characters. The twelfth field is the average width field, which is the average width of the characters. The thirteenth field is the registry of the character set. Finally, the fourteenth field is the encoding field of the character set. The above-noted fourteen field of the XLFD are connected with a “-” and start with the same symbol. An example description of a font by XLFD format is as follows:
-misc-fixed-bold-r-normal—10-90-75-75-c-100-jisx0208.1983-0

It is recognized in the art that Asian languages contain character sets. Each character image, also known as a glyph, in the font is accessed by an up to 16 bit long index. In addition, there is a policy that only encoding schemes that are agreed upon internationally are allowed for encoding of the indexes. As such, one font is commonly not sufficient for Asian languages that have multiple encoding schemes. For example, a Japanese font set usually includes the following three encoding fonts: a font for ASCII characters, a font for Kanji characters, and a font for Kana characters.

In the X Windows system, a font set is created by calling the XCreateFontSet function. This function has an argument called the base font name to select the included fonts. In one embodiment, the XLFD format can be used for the base font name. To create a font set, the user can explicitly specify the base font name. For example, the user can specify a Kanji font name with the following XLFD format:
-misc-fixed-medium-r-normal—14-130-75-75-c-140jisx0208.1983-0

A font set including fonts with the same type face and size is created to describe, i.e. draw or render characters of the same kind. However, since perfect matching is required for the description of the base font name, some characters cannot be specified because the fonts do not have the characters when the font environments are different, such as when the font includes characters of different resolutions. One solution for this shortcoming of font environment is to use wildcard characters ‘*’ as necessary for each field. The following is an example of the use of wildcard characters in the XLFD format:
-*-*-*-r-normal—14-*-*-*-*-*-*-*
   However, in relation to the use of wildcard characters, the prior art does not allow for priorities to be applied to these fields. More specifically, there is no provision to specify the wildcards so that the same weight or same slant can be assigned a priority. Therefore, it is necessary to explicitly specify the weight and slant. However, when the fields to be prioritized are explicitly specified some characters cannot be displayed because the font set may not have the characters since the characters are dependent on the font environment.

Accordingly, there is a need for a font selection process that supports the use of wildcard characters in an XLFD font set while also accommodating assignment of priorities among the fields in the font set selection.

### SUMMARY OF THE INVENTION

This invention comprises a method and system for creating a font set that accommodates wildcard characters and assignment of priorities in conjunction therewith.

In one aspect of the invention, a method is provided for creating a font set by specifying font attributes with an X logical font description, with the font description including a plurality of fields. A priority is assigned to at least one of the fields in the font description using at least a set of two continuous wildcard characters in a single field. The wildcard character represents a character that may be substituted for any other character. A list of matching font names is created from a list of font names provided by an X server through an X library to the specified font attribute. A font set is created by selecting one or more fonts from the X server through the X library based upon the assigned priority.

In another aspect of the invention, a computer system is provided with a processor in communication with memory and storage media. Font characteristics are stored in the storage media. A manager in communication with the processor is provided to specify font attributes with an X logical font description. The font description includes a plurality of fields. The manager assigns a priority to at least one of the fields in the font description through the use of at least a set of two continuous wildcard characters in a single field. The wildcard character represents a character that may be substituted for any other character. A list of matching font names is created by the manager from an X server through an X library of font names to the specified font attributes, and a font set is created by the manager by selection of a font from the X server through the X library based upon the assigned priority.

In yet another aspect of the invention, an article is provided with a computer readable carrier including computer program instructions configured to create a font set. Instructions are provided to specify font attributes with an X logical font description. The font description includes a plurality of fields. Instructions are also provided to assign a priority to at least one of the fields in the font description using at least a set of two continuous wildcard characters in a single field. The wildcard character represents a character that may be substituted for any other character. A list of matching font names is created from a list of font names provided by X server through X library to the specified font attributes. Instructions are provided to create a font set by selecting a font from the X server through X library based upon the assigned priority.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a prior art font mechanism of the X window system.

FIG. 2 is a flow chart illustrating a process for creating a font set that enables selection of one or more fonts to create the font set, with assignment of priorities to one or more fields in a font description, according to the preferred embodiment of this invention, and is suggested for printing on the first page of the issued patent.

FIG. 3 is a block diagram illustrating implementation of the flow chart of FIG. 2.

FIG. 4 is a block diagram of a continuation of the example for matching a font set description with wildcard prioritization entries based on the illustration of FIG. 3.

FIG. 5 is a block diagram of a continuation of the example for matching a font set description with wild card prioritization entries based on the illustration of FIGS. 3 and 4.

FIG. 6 is a block diagram illustrating placement of the font set creation tool in a computer system.

### DESCRIPTION OF THE PREFERRED EMBODIMENT

### Overview

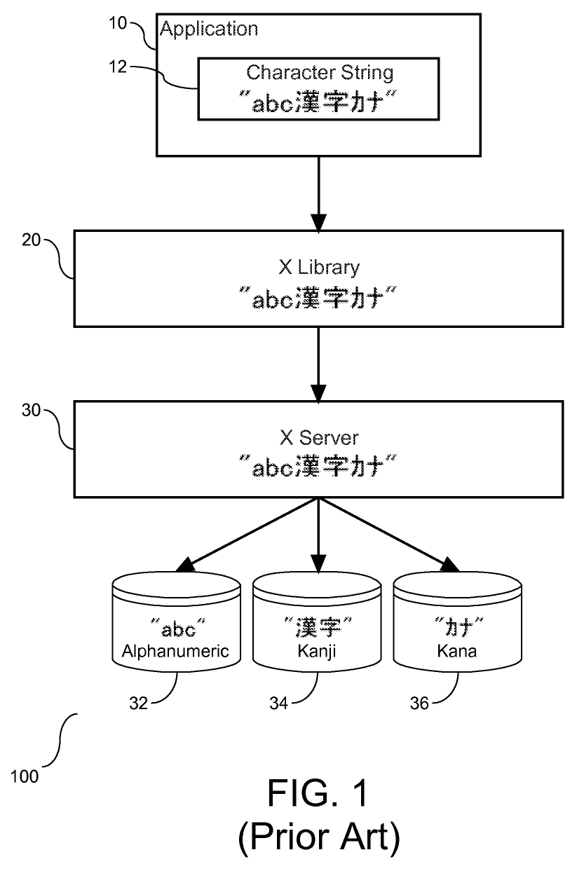

A string of characters that includes alphanumeric characters and Asian language characters cannot all be written with a single font selection. Based on the nature of the characters to be assigned to a font set, each character in the character string is assigned to a character group with each group comprising a font set. The characters are drawn by using the suitable fonts based on the divided character groups. FIG. 1 is a block diagram (100) of a prior art font mechanism of the X window system. As shown, an application (10) is in communication with the X library (20). A character string (12) is introduced by the application (10) to the X library (20). The X library (20) requests to the X server (30) for handling fonts. The necessary fonts for the character string are determined by the character sets necessary to draw the characters. In the example shown herein, the X server has three font files, one alphanumeric (32), one wide Kanji (34), and a third narrow Kana (36). In one embodiment, the alphanumeric font file (32) is assigned the identifier ISO8859-1, the wide Kanji font file (34) is assigned the identifier JISX0208, and the narrow Kana font file (36) is assigned the identifier JISX0201. To create the font set based on the font names, the matching fonts are selected from the character sets. As shown, the first three characters from the string are selected from the alphanumeric font file (32), the second three characters from the string are selected from the wide Kanji font file (34), and the last two characters from the string are selected from the narrow Kana font file (36). For the base font names, the character name(s) can be specified for each field with XLFD.

In addition, wild card characters ‘*’ can be used for some of the fields in the XLFD. A wildcard character is a character that may be substituted for any of a defined subset of all possible characters. An asterisk is commonly used as a wildcard character. Multiple wildcard characters may be implemented for one or more fields together with instructions to implement logic to use the multiple wildcard characters for assignment of a priority to the field in selection of a font set.

### Technical Details

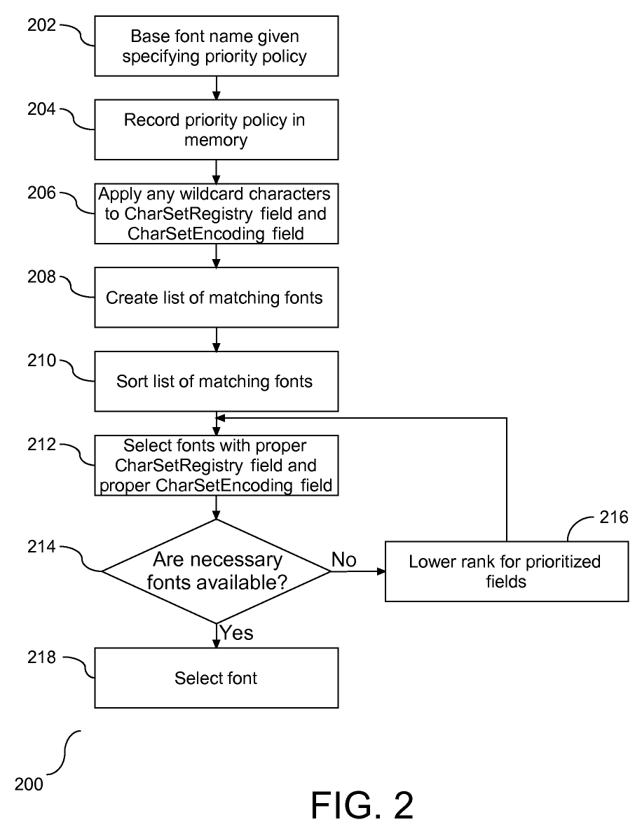

FIG. 2 is a flow chart (200) illustrating a process for creating a font set that enables selection of one or more fonts to create the font set, with assignment of priorities to one or more fields in a font description. Initially, a base font name is given specifying the priorities for the fields (202). The priority policy for the fields is recorded in memory from the base font name (204). Wildcard characters are applied to the CharSetRegistry field and the CharSetEncoding field of the base font name (206). A list of matching fonts is created based upon the base font name (208). The list of matching fonts is sorted in order starting with the higher order fields (210). The order of the listing is based upon the priority policy recorded at step (204). Following the sorting at step (210), the list is checked in order to create a font set by selecting the fonts with the proper CharSetRegistry field and the proper CharSetEncoding field (212). In step (212), the prioritized fields must be the same to be selected. Following step (212), it is determined whether the fonts with the necessary CharSetRegistry field and the CharSetEncoding field are available (214). If it is determined at step (214) that the necessary CharSetRegistry field and the CharSetEncoding field are not available, the rank of the priority policy is lowered for the prioritized fields (216) followed by a return to step (212). However, if it is determined at step (214) that the CharSetRegistry field and the CharSetEncoding field are available, then the font set is selected (218).

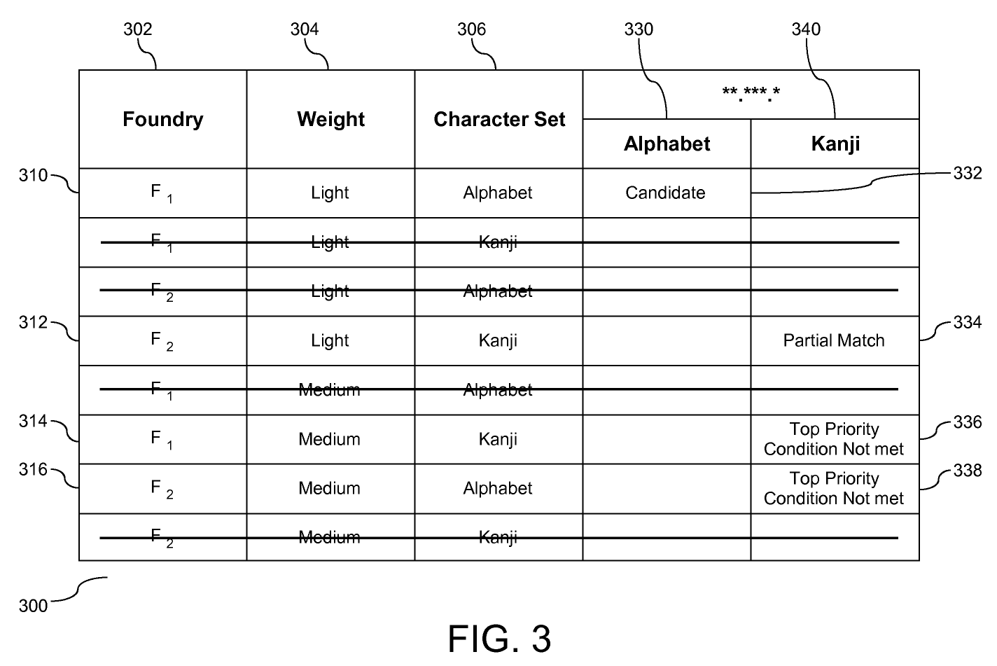

FIG. 3 is a block diagram (300) illustrating implementation of the flow chart of FIG. 2. As shown in the diagram, there are three fields of the XFLD description that have been assigned a priority in the font selection process, the foundry field (302), the weight field (304), and the character set field (306). In this example, the priority policy specified for these three fields are indicated as “-**-***-*”, wherein each of the asterisks represents a wildcard in the font description string. The first field represents the foundry, the second field represents the weight, and the third field represents the character set. As such, the priority is placed in the following order, the weight, the foundry, and the character set. Eight listings are provided with each listing in a separate row. The goal is to provide a listing with the same weight and same foundry for each character set. The listings that are crossed out do not exist and are provided for explanatory purposes. In this example, there are two character sets, Alphabet (330) and Kanji (340). The first listing (310) has the foundry, F₁, the weight, Light, and the Alphabet character set. As such, the first listing is a candidate (332) for a font set selection. The prioritized weight is Light and the prioritized foundry is F1. The goal is now to find a second listing with the same prioritization weight, Light, and foundry, F1, found in the first listing for the Kanji character set. For the purposes of describing the example shown herein, the listing that does not exist is omitted from the detailed description. The fourth listing (312), which is the next available listing, has the non-prioritized foundry, F₂, the prioritized weight, Light, and the Kanji character set. Although the weight portion and the character set portion of the listing match, the foundry portion which is prioritized one level below the weight does not match. Therefore, the second listing is not a perfect match—it is a partial match (334). The next available listing (314), has the prioritized foundry F₁, the non-prioritized weight, and the Kanji character set. However, the top priority condition, weight, is not met and therefore this entry is skipped (336). The fourth entry (316), which is the next available listing, has the non-prioritized foundry, F₂, and the non-prioritized weight, and the Alphabet character set. Since this entry does not have the top priority condition or the sought after character set, this entry is skipped (338). Accordingly, the closest matching entry in the list based upon the qualification is the second listing (312) which include a partial match. Accordingly, in this example, a candidate for the Kanji font that completely meets the set priorities is not found.

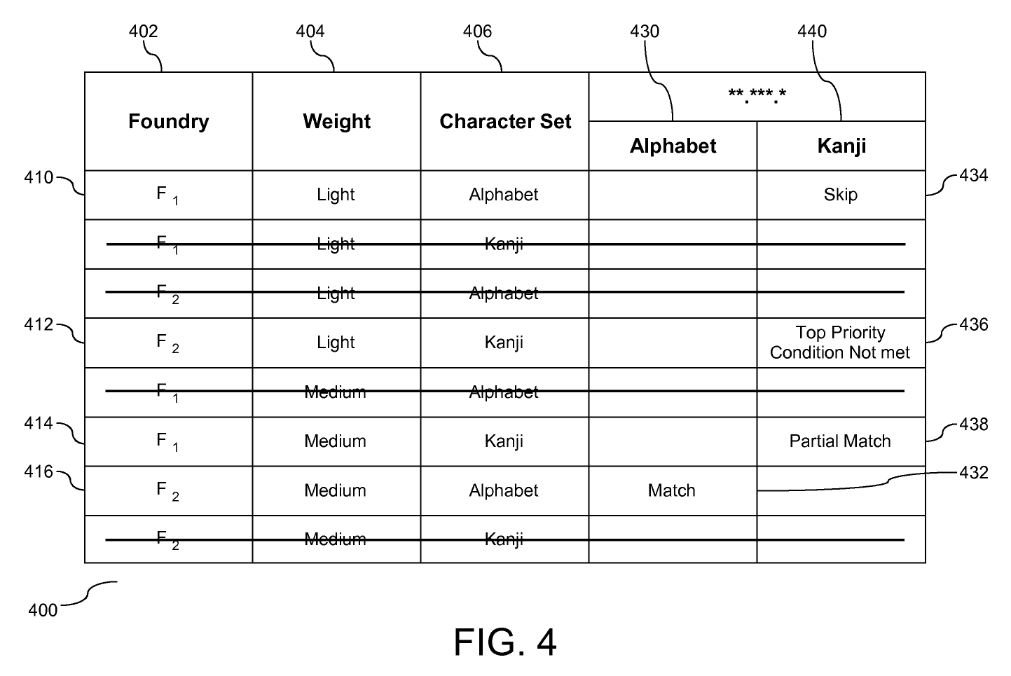

FIG. 4 is a block diagram (400) illustrating implementation of the flow chart of FIG. 2 based upon the prioritization of the foundry and weight as shown in FIG. 3. As shown in the diagram, there are three fields of the XFLD description that have been assigned a priority in the font selection process, the foundry field (402), the weight field (404), and the character set field (406). As in the description of FIG. 3, the prioritization is implemented with the use of wildcard characters, “-**-***-*”, with the top priority set at the weight and the next priority set at the foundry.

As demonstrated in FIG. 3, the goal is to provide a listing with the same weight and same foundry for each character set. The listings that are crossed out do not exist and are provided for explanatory purposes. In this example, there are two character sets, Alphabet (430) and Kanji (440). In FIG. 3, a candidate for the Kanji font that completely met the set priorities was not found. This means that the selection at (310) of the Alphabet font might have been a poor selection. FIG. 4 is a continuation of the example of FIG. 3 to try to find the next candidate of the Alphabet font, which may be a better selection based upon the fonts available for selection. The first font entry (434) is skipped since it has been determined to be a poor candidate for selection. The second available listing (412) is not an Alphabet font, so it is skipped. The fourth available listing (416) is the next listing with an Alphabet font. Listing (416) has a Medium weight, the foundry, F2, and the character set, Alphabet, and is marked as a candidate (432). Based upon the prior candidate at (332), the prioritized weight is now medium and the prioritized foundry is F2. The next candidate for Kanji font on the list subject for review (410) has the first foundry, F₁, a light weight, and the Alphabet character set. None of the elements match the desired set, and this entry is skipped. The next available entry (412) subject for review has the set of the second foundry, F₂, a light weight, and the Kanji character set. The top priority condition, weight, for this query is not met (436). Therefore the process continues for review of the next entry (414) in the list which has an entry with the first foundry, F₁, the correct weight, medium, and the Kanji character set. This entry is a partial match (438) with the highest prioritized item matching the requirements. Accordingly, as shown in this example of the process for font selection, a perfect match based upon the wildcard priorities specified was found for the Alphabet font, but not for the Kanji font.

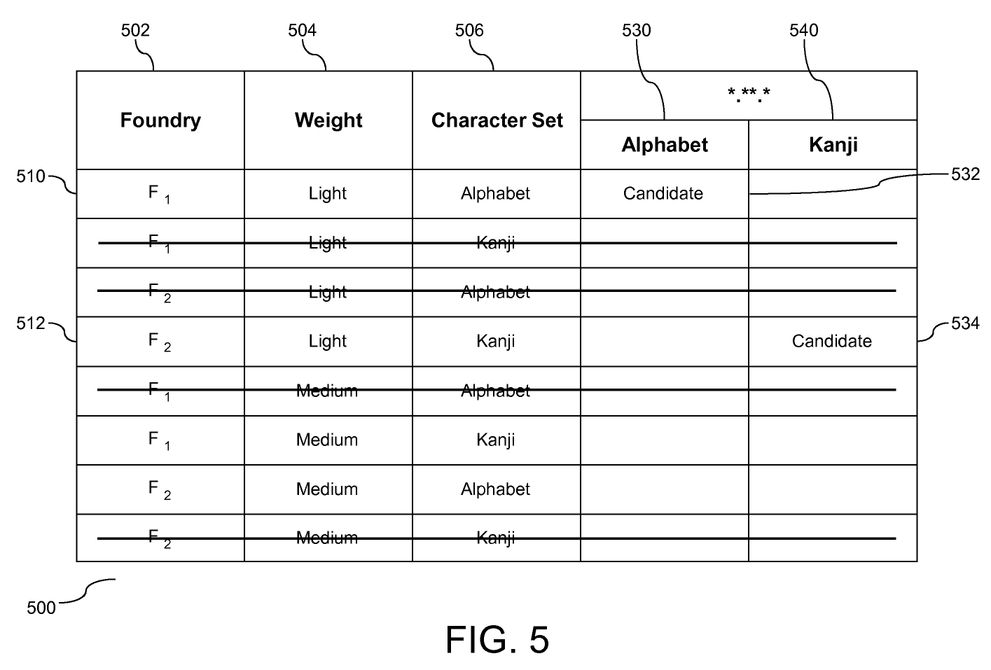

Based upon the process shown in FIGS. 3 and 4, only a perfect match for the Alphabet font was found. The process did not yield a perfect match for the Kanji font based upon the parameters set. FIG. 5 is a block diagram (500) demonstrating the continuation of the process for matching a font set description with wild card prioritization entries based on the example of FIGS. 3 and 4. As shown in the diagram, there are three fields of the XFLD description that have been assigned a priority in the font selection process, the foundry field (502), the weight field (504), and the character set field (506). In this example, the priority policy specified for these three fields has been changed to “-*-**-*” from “-**-***-*” as provided in FIG. 3 and in accordance with the logic for lowering the rank for prioritized fields, as explained at step (216) in FIG. 2, wherein each of the asterisks represents a wildcard in the font description string. As described herein, the priority ranking has been lowered, the weight is still prioritized—the weight must be the same in the selection. The procedure returns to the selection process to find a matching font set. The goal is to provide a listing with the same weight and with any foundry being optional for each character set. In this example, there are two character sets, Alphabet (530) and Kanji (540). The first available candidate (510) with the first foundry F₁, the light weight, and the Alphabet character set is identified in the first listing as a candidate (532). In searching for a listing matching the input string, the listings are searched in the sorted order for a matching Kanji font set. The next available listing (512), has the second foundry F₂, a light weight, and a Kanji character set. The weight of the entry matches the assigned priority, and is the only prioritized field in this search. Since the priority originally assigned to the foundry has been removed, the entry at (512) is now a candidate (534) as the remaining fields of the entry are a match. The font set creation logic found two fonts one for Alphabet and one for Kanji. Accordingly, in this example and with the logic pertaining to lowering the rank for prioritized fields, a candidate for the Kanji font that completely meets the set priorities is found.

As shown in FIG. 2 at step (210) and demonstrated in the example of FIGS. 3, 4, and 5, the list of matching fonts is sorted in order from the higher order fields. During the matching process, the sorting of the fonts may mitigate the quantity of fonts that are reviewed to find a match. For example, as shown in FIG. 5, the quantity of wildcard entries for both the foundry and the weight was reduced, while maintaining the quantity of wildcard entries in the weight greater than the foundry. Based upon the entries in the list, a match for the font set was found in one of the higher ranked entries.

In one embodiment, the invention is implemented in software, which includes but is not limited to firmware, resident software, microcode, etc. The invention can take the form of a computer program accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

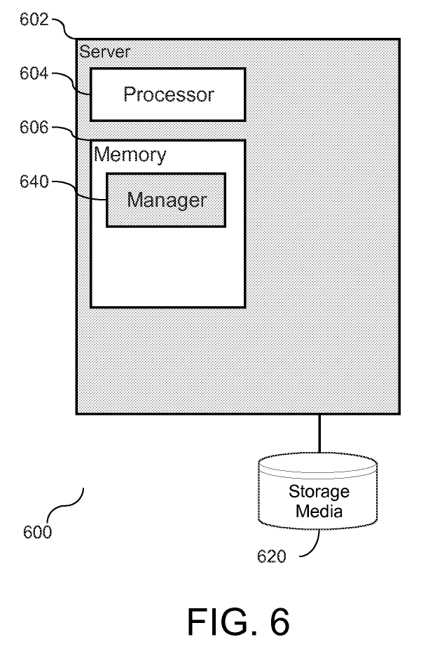

FIG. 6 is a block diagram (600) illustrating placement of the font set creation tool in a computer system. The illustration shows a server (602) with a processor (604), and memory (606) in communication with storage media (620). A font set creation tool in the form of a manager (640) is shown residing in memory (606) of the server (602). The manager (640) mediates and facilitates selection of fonts to create a font set that supports different character sets, as described in detail in FIGS. 2-5 above. The manager (640) may utilize instructions in a computer readable medium to mediate selection of appropriate font sets. In one embodiment, the server (602) is an X Server in communication with an X Library residing in the storage media (620). A list of matching font names is created by the manager (640) by using font names obtained from the X Server (602) through the X Library residing in the storage media (620) by specifying the specified font attributes. Similarly, a font set is created by the manager (640) through selection of a font from the X Server (602) through the X Library based upon the assigned priority. Similarly, in one embodiment, the manager (640) may reside as a hardware tool external to memory (606), or it may be implemented as a combination of hardware and software. Accordingly, the manager (640) may be implemented as a software tool or a hardware tool to facilitate creation of a font set that supports customized establishment of priorities of different characteristics necessary for the font set to be created.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

### Advantages Over The Prior Art

The established XLFD specification for the description rule of the font attributes is maintained to create a font set. Multiple wildcard characters may be utilized for one or more fields in the XLFD specification to designate a ranking of one or more of the fields in view of the other fields within the specification. The priorities for each of the fields in the XLFD specification are specified by the quantity of wildcard characters for each field of the base font name given when creating the font set. When wildcard characters are specified for multiple fields, it is possible to specify the priorities of the application for the fields.

### Alternative Embodiments

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A method for creating a font set comprising:
specifying font attributes with an X logical font description, wherein said font description includes a plurality of fields;
assigning a priority to at least one of said fields in said font description using at least a set of two continuous wildcard characters in a single field, wherein said wildcard character represents a character that may be substituted for another other character;
creating a list of matching font names from an X server through an X library to said specified font attributes; and
creating a font set by selecting a font from said X server through said X library based upon said assigned priority.

2. The method of claim 1, wherein said set of two continuous wildcard characters has an equivalent meaning to a single wildcard character.

3. The method of claim 1, further comprising creating a list of matching font names using said set of continuous wildcard characters in said font description.

4. The method of claim 3, further comprising sorting said created list of matching font names in order from a higher order field.

5. The method of claim 4, further comprising selecting fields in the sorted list based upon prioritization of the fields assigned multiple wildcard entries in a single field.

6. The method of claim 1, further comprising lowering a rank of a priority on a prioritized field by removing a single wildcard character in a field when no entries in the list match the prioritization.

7. A computer system comprising:
a processor in communication with memory and storage media;
font characteristics stored in said storage media;
a manager to specify font attributes with an X logical font description, wherein said font description includes a plurality of fields;
said manager to assign a priority to at least one of said fields in said font description using at least a set of two continuous wildcard characters in a single field, wherein said wildcard character represents a character that may be substituted for any other character;
a list of matching font names created by said manager from an X server through an X library to said specified font attributes; and
a font set created by said manager by selection of a font from said X server through said X library based upon said assigned priority.

8. The system of claim 7, wherein said set of two continuous wildcard characters has an equivalent meaning to a single wildcard character.

9. The system of claim 7, wherein said manager creates a list of matching font names using said set of continuous wildcard characters in said font description.

10. The system of claim 9, further comprising said manager to sort said created list of matching font names in order from a higher order field.

11. The system of claim 10, further comprising said manager to select fields in the sorted list based upon prioritization of the fields assigned multiple wildcard entries in a single field.

12. The system of claim 7, further comprising said manager to lower a rank of a priority on a prioritized field by removing a single wildcard character in a field when no entries in the list match the prioritization.

13. An article comprising:
a computer readable carrier including computer program instructions configured to create a font set, comprising:
instructions to specify font attributes with an X logical font description, wherein said font description includes a plurality of fields;
instructions to assign a priority to at least one of said fields in said font description using at least a set of two continuous wildcard characters in a single field, wherein said wildcard character represents a character that may be substituted for any other character;
instructions to create a list of matching font names from an X server through an X library of font names to said specified font attributes; and
instructions to create a font set by selecting a font from said X server through said X library based upon said assigned priority.

14. The article of claim 13, wherein said set of two continuous wildcard characters has an equivalent meaning to a single wildcard character.

15. The article of claim 13, further comprising instructions to create a list of matching font names using said set of continuous wildcard characters in said font description.

16. The article of claim 15, further comprising instructions to sort said created list of matching font names in order from a higher order field.

17. The article of claim 16, further comprising instructions to select fields in the sorted list based upon prioritization of the fields assigned multiple wildcard entries in a single field.

18. The article of claim 13, further comprising instructions to lower a rank of a priority on a prioritized field by removing a single wildcard character in a field when no entries in the list match the prioritization.
